(19) United States
(12) Patent Application Publication
(10) Pub. No.: US 2020/0275182 A1
(43) Pub. Date: Aug. 27, 2020

(54) ORNAMENTAL EARPIECE FIXTURE AND KIT ASSEMBLY FOR AN EARPIECE

(71) Applicant: Claus ETTENSBERGER, Los Angeles, CA (US)

(72) Inventor: Claus ETTENSBERGER, Los Angeles, CA (US)

(21) Appl. No.: 16/286,882

(22) Filed: Feb. 27, 2019

(51) Int. Cl. H04R 1/10

(52) U.S. Cl. CPC H04R 1/1016; H04R 1/1041

(57) ABSTRACT

An earphone fixture and kit assembly for an earphone wherein the earphone is comprised of an ear bud and a stem, the earphone fixture and kit assembly comprising a stem fixture for substantially surrounding the earphone stem. The stem fixture has a clamshell configuration with a hinge and a closure mechanism to permit closure around the stem. A friction lining is disposed on an inner surface of said stem fixture to provide a friction interface between the stem fixture and the stem. At least one or a plurality of interchangeable external ornamental features are selectively and interchangeably affixed to the stem fixture, wherein one of the interchangeable external ornamental features is affixed to the stem fixture in the absence of all other interchangeable external ornamental features. A hanging member may be affixed to the stem fixture to hang below the stem fixture to provide additional ornamentation to earphone.

### FIELD OF THE INVENTION

The present invention relates to an earphone fixture for an earphone, and more specifically an earphone fixture, including an ear bud skin and ornamentation for an earphone having an ear bud and a stem.

### BACKGROUND OF THE INVENTION

Apple Inc.® has introduced in September 2016 wireless earbuds or earpieces called AirPods® 100, which is compatible with iPhone® or iPad®. See http://www.apple.com/shop/product/MMEF2AM/A/airpods. As illustrated in FIGS. 1 and 2, AirPods® 100 are ear-bud style earpieces 100 having an ear bud 110 and a stem 120 and can be charged in a charging case (not shown) which has its own battery.

Earphones 100 such as AirPods 100 include an ear bud 110 and a stem 120. A primary speaker outlet 130 is formed on the ear bud 110 and the ear bud 110 further includes first and second secondary speaker outlets 131, 132. Grilles are formed on each of the speaker outlets 130, 131, AirPods 100 further includes sensors 140, 141 to detect whether or not AirPods 100 are in user's ear. The stem 120 adopts a longitudinal profile to store an antenna and battery therein. When a user wears an Airpod, the stem 120 is shown to be downwardly longitudinal and/or downwardly extends from the ear bud 110. The ear bud 110 is constructed to be inserted into user's ear canal 210.

However, AirPods 100 do not present an attractive appearance to some users and fail to provide fixtures for altering the appearance and seating position for the earpiece.

The present invention is directed to overcome such a disadvantage and provides a number of other advantages when adopted with wireless ear-bud style earpieces 100 having an ear bud 110 and a stern 120.

### SUMMARY OF THE INVENTION

The present invention is directed to an earphone fixture, including a stem fixture and interchangeable ornamentation, for an earphone having an ear bud and a stem. The ear bud fixture has first and second openings. The ear bud fixture receives the ear bud. The first opening surrounds and encloses a primary stem of the earphone and the stem passes through the second opening in order for the earphone to be received in the earphone fixture. The fixture is provided with an external surface provided with ornamentation selected by the user for enhanced appearance and comfortability. An inner friction sleeve is fitted to the interior surface of the skin portion.

The object of the present invention is to provide an earphone fixture for an earphone where the earphone includes an ear bud and a stem. The ear bud is inserted into user's ear canal and the stem extends from the ear bud where, additionally, a primary speaker outlet is formed thereon. Furthermore, the earphone fixture includes an ear bud fixture that substantially surrounds the ear bud stem of the earphone and increases the friction between the ear bud and the fixture.

Still another object of the present invention is to provide a method and kit for using an earphone fixture constructed for an earphone. The method may include steps for easy application of the earphone fixture onto the earphone stem. The method may further include steps for easy removal of the earphone fixture from the earphone. The steps for application include the step of enclosing the stem with a clam-shell design having interchangeable ornamentation affixed to the fixture.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIGS. 1 and 2 show Apple Inc.®'s AirPods®;

FIGS. 3A and 3B illustrate a side view of the earphone fixture of the present invention;

FIGS. 4A and 4B illustrate a top view of the earphone fixture of the present invention;

FIGS. 5A and 5B illustrate the top view of the earphone fixture of FIG. 3A and 3B in an open position;

FIGS. 6A and 6B illustrate the earphone fixture having the earphone therein according to the present invention;

FIGS. 7A and 7B illustrate the earphone fixture having the earphone therein and illustrating a selectively interchangeable ornamentation extending downwardly to provide additional ornamentation for the earphone fixture.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

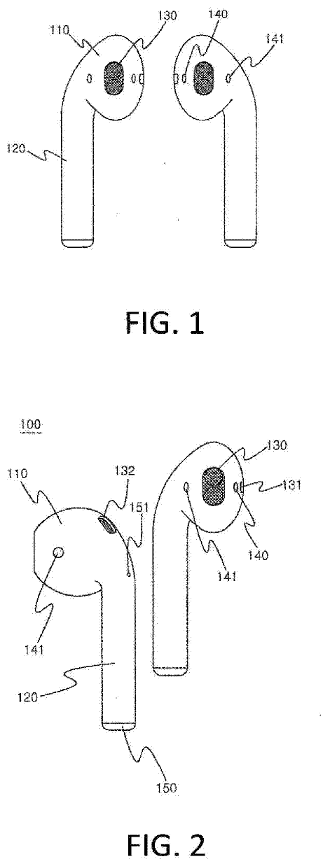

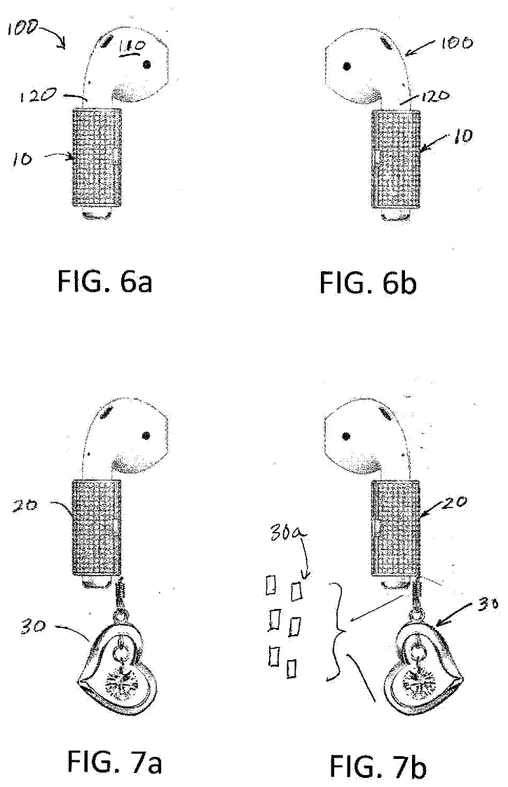

As illustrated in FIGS. 1-2 and 6A and 6B, an earphone fixture 10 for an earphone 100 where the earphone 100 (see FIGS. 1 and 2) includes an ear bud 110 having a primary speaker outlet 130 and a stem 120, and where the ear bud 110 is inserted into user's ear canal (known to those skilled in the art) and the stem 120 extends from the ear bud 110, the earphone fixture 10 (see FIGS. 6 and 7) includes an ear bud fixture 20 for substantially surrounding the stem 120 of the earphone 100 and a friction liner 24 is provided for increasing friction between the earphone fixture 10 and stem 120; and a optional ornamental extension 30 which may extend from the fixture 20 for additional ornamentality. The earphone fixture 10 may be sufficiently flexible and elastic to accept insertion of the earphone stem 120 therein.

Further, as shown in FIGS. 1 and 2, the speaker outlet is where the sound is output and AirPods 100 has three speaker outlets—one primary speaker outlet 130 and the first and second secondary speaker outlets 131, 132. Each speaker outlet has a grille. Furthermore, AirPods has two proximity sensors 140, 141. The first secondary speaker outlet 131 is next to the proximity sensor 140. AirPods further includes a primary microphone 150 and a secondary microphone 151.

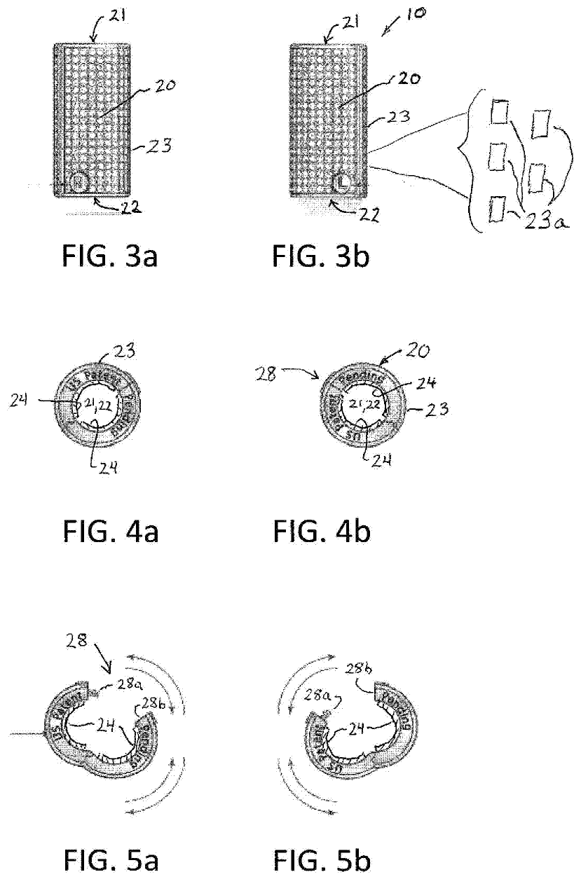

FIGS. 3A and 3B illustrate an earphone fixture 10 that substantially surrounds the stem 120 of the earphone 100 with an inner liner 24 to increase friction between the ear phone fixture 10. The inner liner 22 may be formed of felt or any similar material that will increase friction with the stem 120 without causing damage thereto. In the preferred embodiment, the inner liner 24 is split to accommodate the hinge and clasp arrangement as described below with respect to FIGS. 5A and 5B.

The earphone fixture 10 is formed as a base member 20 and an ornamental outer appendage 23 formed with jewels, precious stones or other type of ornamental feature typical in the art of earrings. Notably, the outer appendage may be removable and replaceable with a plurality of similar appendages (shown schematically as elements 23a in FIG. 3b). In one embodiment, the system and method of this invention provides a kit comprising a plurality of removeable and replaceable outer appendages 23a which interchangeable fit onto the base member 20 so the user can selectively affix a chosen outer appendage 23a onto the base member 20.

The earphone fixture 10 prefably has sufficient stiffness or rigidity to securely retain the inserted earphone 100 and friction between the earphone fixture 10 and the earphone 100 is of sufficient strength to prevent slippage of the earphone 100 out of the earphone fixture 10.

The earphone fixture body 20 includes a first opening 21 and a second opening 22 (see FIGS. 3A and 4A). The first and second openings 21, 22 are sized to allow passage of the stem 120 even if the hinge and clasp assembly of FIGS. 5A and 5B is not provided.

FIGS. 6A and 6B illustrate the passage of the stem 120 through the first and second opening 21, 22 whereby the fixture body 20 substantially surrounds the stem 120. “Surround” here means the boundary of the openings 21, 22 encircles more than half the perimeter of the stem 120. A space of gap may be provided to allow access to he stem when the stem is provided with certain control features such as volume control. In other words, the fixture body 20 may provide access to control features provided on the stem such as a slide volume system operated by the user's finger(s).

Further, FIGS. 5A and 5B depict the hinge and clasp system of the present invention. As shown in FIG. 5A, the fixture body 20 is formed as a clam-shelled configuration having a hinge 26 interconnecting two halves of the fixture body 20 and a clasp system 28 shown as a claw and detent mechanism with a claw 28a formed on one half of the fixture body 20 and a detent 28b provided on the other half pf the fixture body 20. The detent 28b is formed as a catch for the claw 28a to securely close and lock the fixture body 20 in the closed position shown in FIGS. 4A, 4B, 6A and 6B. A release mechanism 28c is provided adjacent the claw 28a to permit release of the claw 28a from the detent 28b by the user pushing or sliding the release mechanism 28c to disengage the claw 28a from the detent 28b. The claw and detent mechanism shown in FIGS. 4A, 4B, 5A, 5B is provided by way of example and is not intended to be limiting of the present invention which provides a unique system and method for providing a removable and replaceable ornamental fixture for an earpiece.

The earphone (100) further includes a first sensor (140) and a first secondary speaker outlet (131) and the extended portion (24) is placed on the first sensor (140) and the first secondary speaker (131). The earphone (100) further includes a second sensor (141) and a second secondary speaker outlet (132) and the ear bud skin (20) further includes openings (25) respectively for the second sensor (141) and the second secondary speaker outlet (132).

In alternate embodiments, the earphone fixture 10 is constructed as one-piece of soft or semi-rigid material or any other elastic material. The soft material is flexible and elastic and has the property of certain degree of friction against hard plastic surface to allow insertion and removal of the earphone 100 into or from the earphone fixture 10 and maintain the orientation of the earphone fixture 10 against the inserted earphone 100. In some embodiments, the earphone fixture 10 is made of silicone, to provide not only a secure fit between the earphone 100 with the earphone fixture 10 and the user's ear but also a comfortable fit.

The earphone 100 (see FIGS. 1 and 2) further includes a secondary microphone 151 formed on the stem 120 and the earphone fixture 10 does not cover the secondary microphone 151.

As shown in FIGS. 7A and 7B, the fixture body 20 may further be provided with an additional hanging member 30 which hangs from the fixture body 20 to provide additional ornamentation. The additional hanging members is preferably provided from a series or plurality of selectively interchangeable elements 30a that may define an ornamentation kit for the user who may interchange different hanging members 30 from the kit.

While the invention has been shown and described with reference to different embodiments thereof, it will be appreciated by those skilled in the art that variations in form, detail, compositions and operation may be made without departing from the spirit and scope of the invention as defined by the accompanying claims.

The claims are as follows:

1. An earphone fixture assembly for an earphone, wherein the earphone comprises an ear bud and a stem, wherein the earbud is configured to be inserted into a user's ear canal and the stem extends downward from the ear bud,. wherein a primary speaker outlet is formed on the ear bud, and wherein the earphone comprises a primary microphone at the bottom of the stem and a secondary microphone at a top portion of the stem, the earphone fixture assembly comprising:
a stem fixture for substantially surrounding the earphone stem, said stem fixture having a clamshell configuration with a first clamshell section and a second clamshell section, said first clamshell section being joined with said second clamshell section by a hinge,. and a closure mechanism to permit closure around said stem, said closure mechanism comprising a claw located on said first clamshell section and a detent on said second clamshell section, said stem fixture having opposite openings to permit passage of said stem therethrough, wherein said stem fixture completely surrounds a perimeter of said stem with said stem passing through said opposite openings when the closure mechanism is closed, wherein said stem fixture is arranged to expose an end portion of said stem at the bottom of the stem to avoid obstructing the primary microphone, wherein said stem fixture is arranged to expose an end portion of said stem at the top portion of the stem to avoid obstructing the secondary microphone;
an external ornamental feature affixed to an external surface of said stem fixture, wherein the external surface substantially surrounds the earphone stem; and
a friction lining disposed on an inner surface of said stem fixture to provide a friction interface between said stem fixture and said stem, wherein the friction lining is split to accommodate said closure mechanism.

2. The earphone fixture assembly according to claim 1, wherein the external ornamental feature affixed to the external surface of said stem fixture substantially surrounds an entirety of the stem.

3. The earphone fixture assembly according to claim 1, wherein said external ornamental feature is selected from a group consisting of a plurality of interchangeable external ornamental features that are selectively and interchangeably affixed to said stem fixture.

4. (canceled)

5. The earphone fixture assembly according to claim 1, wherein said stem fixture partially surrounds a perimeter of said stem with said stem passing through said opposite openings, said stem fixture defining an access opening in said stem fixture intermediate said opposite openings to access an electronic control feature provided on said stem.

6. (canceled)

7. (canceled)

8. The earphone fixture assembly according to claim 1, further comprising a hanging member affixed to said stem fixture and hanging below said stem fixture and said stem to provide additional ornamentation to said stem fixture.

9. The earphone fixture assembly according to claim 8, wherein said hanging member is selected from a group consisting of a plurality of interchangeable hanging members that are selectively affixed to said stem fixture.

10. (canceled)

11. An earphone fixture kit assembly for an earphone, wherein the earphone comprises an ear bud and a stem, wherein the earbud is configured to be inserted into a user's ear canal and the stem extends downward from the ear bud, wherein a primary speaker outlet is formed on the ear bud, and wherein the earphone comprises a primary microphone at the bottom of the stem and a secondary microphone at a top portion of the stem, the earphone fixture assembly kit comprising:
a stem fixture for substantially surrounding the earphone stem, said stem fixture having a clamshell configuration with a first clamshell section and a second clamshell section, said first clamshell section being joined with said second clamshell section by a hinge and a closure mechanism to permit closure around said stem, said closure mechanism comprising a claw located on said first clamshell section and a detent on said second clamshell section, said stem fixture having opposite openings to permit passage of said stem therethrough, wherein said stem fixture completely surrounds a perimeter of said stem with said stem passing through said opposite openings when the closure mechanism is closed, wherein said stem fixture is arranged to expose an end portion of said stem at the bottom of the stem to avoid obstructing the primary microphone, wherein said stem fixture is arranged to expose an end portion of said stem at the top portion of the stem to avoid obstructing the secondary microphone;
an external ornamental feature affixed to an external surface of said stem fixture, wherein the external surface substantially surrounds the earphone stem;
a friction lining disposed on an inner surface of said stem fixture to provide a friction interface between said stem fixture and said stem, wherein the friction lining is split to accommodate said closure mechanism; and
a plurality of interchangeable external ornamental features that are selectively and interchangeably affixed to said stem fixture, wherein one of said plurality of interchangeable external ornamental features is affixed to said stem fixture in the absence of all other interchangeable external ornamental features.

12. The earphone fixture kit assembly according to claim 11, further comprising a hanging member affixed to said stem fixture and hanging below said stem fixture and said stem to provide additional ornamentation to said stem fixture.

13. The earphone fixture kit assembly according to claim 12, wherein said hanging member is selected from a group consisting of a plurality of interchangeable hanging members that are selectively affixed to said stem fixture.

14. The earphone fixture kit assembly according to claim 12, wherein the external ornamental feature affixed to the external surface of said stem fixture substantially surrounds an entirety of the stem.
